(19) United States
(12) Patent Application Publication
(10) Pub. No.: US 2026/0355873 A1
(43) Pub. Date: Nov. 12, 2026

(54) SUPPLY DEVICE, ROBOT DEVICE, AND SUPPLY METHOD

(71) Applicant: DAIFUKU CO., LTD., Osaka (JP)

(72) Inventors: Shingo HASHIMOTO, Hino-cho (JP); Kaname FUJIMORI, Hino-cho (JP); Takashi KIMURA, Hino-cho (JP)

(73) Assignee: DAIFUKU CO., LTD., Osaka (JP)

(21) Appl. No.: 19/670,660

(22) Filed: May 7, 2026

(30) Foreign Application Priority Data
May 12, 2025 (JP) 2025-079981

(51) Int. Cl. B23P 19/00; B25J 11/00

(52) U.S. Cl. CPC B23P 19/002; B23P 19/007; B25J 11/005

(57) ABSTRACT

A supply device that can be reduced in size is provided. A supply device includes: a feed mechanism that includes a plurality of retention parts for retaining a bolt and that feeds the bolt in a linear direction by movement of the plurality of retention parts within a certain region; and a supply mechanism that includes (i) a gripping mechanism that grips the bolt fed by the feed mechanism and (ii) a moving mechanism that moves the gripping mechanism so as to supply the bolt to a nutrunner that performs work with use of the bolt.

This Nonprovisional application claims priority under 35 U.S.C. § 119 on Patent Application No. 2025-079981 filed in Japan on May 12, 2025, the entire contents of which are hereby incorporated by reference.

### TECHNICAL FIELD

The present invention relates to a supply device that supplies an article to be supplied, and the like.

### BACKGROUND ART

A supply device is known that supplies an article to be supplied, such as a component, to a predetermined position. For example, Patent Literature 1 discloses a bolt supply device in which a gripping body of a supply chuck device grips a bolt loaded facing upward in a magazine, lifts the bolt to take the bolt out, moves the bolt to above a bolt fastening device, then lowers the bolt, and supplies the bolt to a wrench part of the bolt fastening device. In the magazine, when a bolt is taken out by the gripping body from a bolt take-out part, a bolt in a bolt loading part is pushed out toward the bolt take-out part by a bolt pushing-out part.

### CITATION LIST

### Patent Literature

### Patent Literature 1

Japanese Patent Application Publication, Tokukai, No. 2013-56383

### SUMMARY OF INVENTION

### Technical Problem

In the above supply device, the magazine only retains bolts, and in order to move bolts within the magazine, it is necessary for the bolt pushing-out part to push out bolts in the bolt loading part of the magazine toward the bolt take-out part. The bolt pushing-out part includes a rod-shaped member which is provided so as to extend laterally of the magazine. As such, there is a problem that the bolt pushing-out part causes an increase in size of the bolt supply device.

An object of an aspect of the present invention is to provide a supply device that can be reduced in size.

### Solution to Problem

In order to attain the object, a supply device in accordance with an aspect of the present invention includes: a feed mechanism that includes a plurality of retention parts for retaining an article to be supplied and that feeds the article in a linear direction by movement of the plurality of retention parts within a certain region; and a supply mechanism that includes (i) a gripping mechanism that grips the article fed by the feed mechanism and (ii) a moving mechanism that moves the gripping mechanism so as to supply the article to a work device that performs work with use of the article.

In order to attain the object, a supply method in accordance with an aspect of the present invention includes: a feeding step of feeding an article to be supplied with use of a feed mechanism that includes a plurality of retention parts for retaining the article and that feeds the article in a linear direction by movement of the plurality of retention parts within a certain region; and a supply step of, while gripping the article fed by the feed mechanism, moving the article so as to supply the article to a work device that performs work with use of the article.

### Advantageous Effects of Invention

An aspect of the present invention makes it possible to provide a supply device that can be reduced in size.

### BRIEF DESCRIPTION OF DRAWINGS

FIG. 1 is a perspective view illustrating a configuration of a robot device in accordance with an embodiment of the present invention.

FIG. 2 is a perspective view illustrating configurations of a nutrunner and a supply device in the robot device.

FIG. 3 is a plan view illustrating a structure for retaining a bolt in a feed mechanism that feeds the bolt to be supplied to the nutrunner.

FIG. 4 is a perspective view illustrating a configuration of a magazine in the robot device.

FIG. 5 is perspective views illustrating an operation in which the supply device supplies the bolt to the nutrunner.

FIG. 6 is a front view illustrating a configuration of a feed mechanism in accordance with Variation 1 of the present embodiment.

FIG. 7 is a front view illustrating a state in which the bolt is fed by the feed mechanism illustrated in FIG. 6.

FIG. 8 is a front view illustrating a configuration of a feed mechanism in accordance with Variation 2 of the present embodiment.

FIG. 9 is a front view illustrating a state in which the bolt is fed by the feed mechanism illustrated in FIG. 8.

### DESCRIPTION OF EMBODIMENTS

### Embodiment

The following description will discuss an embodiment of the present invention in detail.

### Configuration of Robot Device

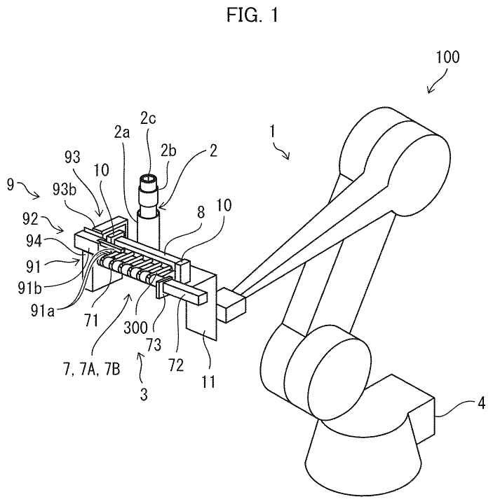

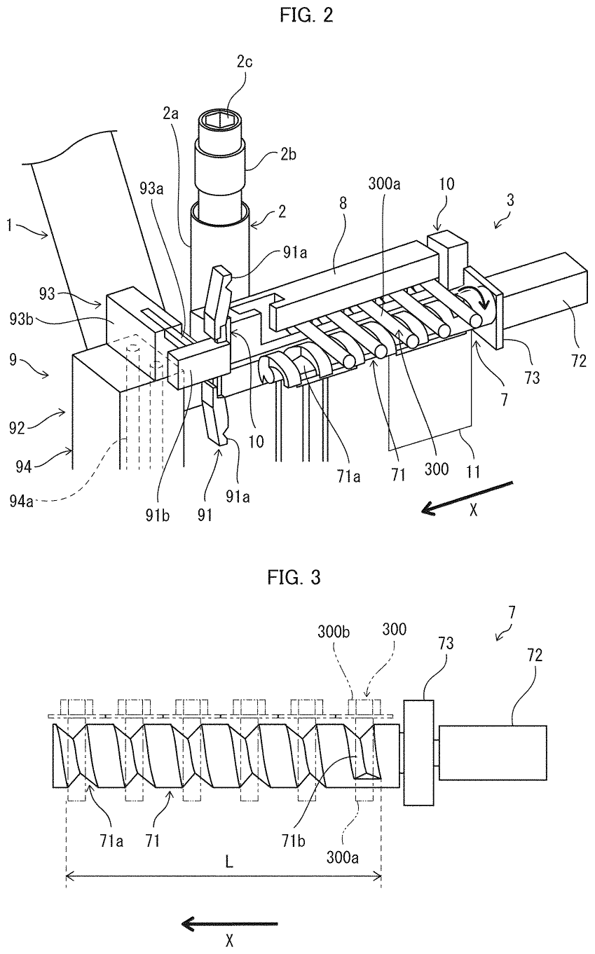

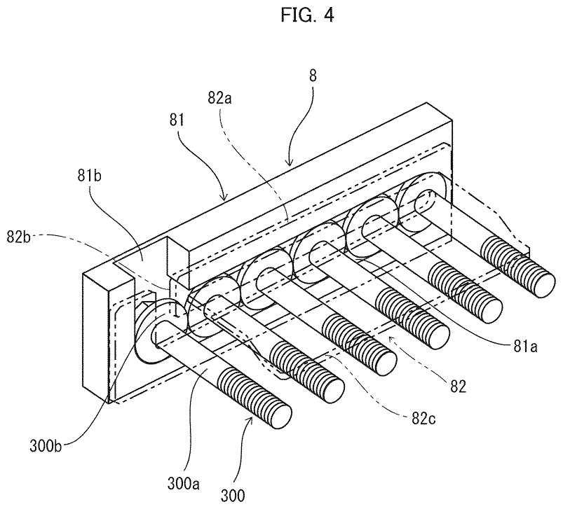

FIG. 1 is a perspective view illustrating a configuration of a robot device 100 in accordance with an embodiment of the present invention. FIG. 2 is a perspective view illustrating configurations of a nutrunner 2 and a supply device 3 in the robot device 100. FIG. 3 is a plan view illustrating a structure for retaining a bolt 300 in a feed mechanism 7 that feeds the bolt 300 to be supplied to the nutrunner 2. FIG. 4 is a perspective view illustrating a configuration of a magazine 8 in the robot device 100.

As illustrated in FIG. 1, the robot device 100 includes a robot arm device 1, the nutrunner 2 (work device), the supply device 3, and a control device 4.

Note that the robot device 100 is not limited to a form including the robot arm device 1. For example, the robot device 100 may include a self-propelled carriage in place of the robot arm device 1.

The robot arm device 1 is a vertical articulated robot having a plurality of joints that are rotatable and is capable of complex movements. A support frame 11 is provided at a distal end of the robot arm device 1. The support frame 11 is provided with the nutrunner 2 and the supply device 3. The robot arm device 1 is installed, for example, on a floor surface.

The nutrunner 2 is a bolt fastening machine that performs an operation of fastening a bolt 300 (article supplied) using the bolt 300. The nutrunner 2 can communicate with the control device 4 and operates upon receiving control instructions from the control device 4. The nutrunner 2 includes a support cylinder 2a, a movable part 2b, and a socket 2c.

The support cylinder 2a is disposed on an upper surface of the support frame 11 and is provided, for example, so as to stand upright perpendicularly to the upper surface of the support frame 11. Although not illustrated, a drive mechanism that moves the movable part 2b up and down in a direction of a central axis of the nutrunner 2 is provided inside the support cylinder 2a. The movable part 2b is formed in a tubular shape having a diameter that fits inside the support cylinder 2a. The movable part 2b is disposed so that a part thereof can protrude from and retract into the interior of the support cylinder 2a and moves up and down relative to the support cylinder 2a by the above drive mechanism. By being configured in this manner, the nutrunner 2 is provided so as to be extendable and retractable such that the position of the socket 2c can be changed.

The socket 2c is a prescribed portion to which the bolt 300 is supplied. The socket 2c is provided on a distal end surface of the movable part 2b and has a recess whose shape allows a head 300b (see FIG. 4) of the bolt 300 to be fitted. The bolt 300 is a flanged bolt, and the head 300b includes a hexagonal part of hexagonal shape and a flange part. The flange part is provided at a base portion of a shank 300a of the bolt 300, and is a collar portion formed in a circular shape and having a diameter larger than that of the shank 300a.

The supply device 3 is a device that supplies the bolt 300 from the magazine 8 to the nutrunner 2. As illustrated in FIG. 2, the supply device 3 includes the feed mechanism 7, the magazine 8, a supply mechanism 9, and a retention mechanism 10.

The feed mechanism 7 is a mechanism that feeds the bolt 300 in a linear direction. The feed mechanism 7 includes a shaft 71, a motor 72, and a support 73. A helical groove 71a is formed in an outer circumferential surface of the shaft 71. The motor 72 drives the shaft 71 so as to rotate about a central axis of the shaft 71. The support 73 is a plate-like member that supports the feed mechanism 7 on the support frame 11. The shaft 71 is fixed to one side of the support 73, and the motor 72 is fixed to the other side of the support 73.

On the helical groove 71a in the feed mechanism 7, shanks 300a of a plurality of bolts 300 are disposed such that a longitudinal direction of each of the shanks 300a is perpendicular to the central axis of the shaft 71 and that the shanks 300a are arranged in a straight line along the central axis. The shaft 71 of the feed mechanism 7 rotates so that the position of the helical groove 71a on which the shanks 300a are disposed moves toward a distal end of the shaft 71, as indicated by an arrow X. By this, the feed mechanism 7 moves the shanks 300a toward the distal end of the shaft 71.

Note that the feed mechanism 7 may be configured by a screw feeder. The screw feeder is a conveyance device having a shaft, such as the shaft 71, that is rotationally driven, and screw flights formed on an outer circumferential surface of the shaft. Such a screw feeder has a helical groove formed between the screw flights along a direction in which the shaft extends. By treating this groove like the above helical groove 71a, it is possible to retain the shanks 300a of the bolts 300 on the groove.

As illustrated in FIG. 3, in the helical groove 71a, portions on which the shanks 300a of the bolts 300 are disposed form a plurality of retention parts 71b that respectively retain the plurality of shanks 300a. The plurality of retention parts 71b move, by rotation of the shaft 71, toward the distal end of the shaft 71 in a direction of the central axis of the shaft 71 as indicated by an arrow X, within a certain region having a prescribed length L. The retention parts 71b retain the shanks 300a such that the shanks 300a are oriented substantially perpendicular to a direction in which the nutrunner 2 faces, that is, the direction of the central axis of the nutrunner 2. This makes it possible to secure a large gap between the feed mechanism 7 including the retention parts 71b and the socket 2c of the nutrunner 2.

Note that the orientation of the shanks 300a retained by the retention parts 71b is not limited to the above example and is appropriately set according to the structure of the retention parts 71b and a direction in which the nutrunner 2 extends.

The feed mechanism 7 is disposed on a side opposite to a side on which the nutrunner 2 is disposed, with the magazine 8 interposed therebetween. Specifically, the feed mechanism 7 is disposed such that a distal end part of the shaft 71 is aligned with the nutrunner 2 with a discharge side of the magazine 8, from which the bolts 300 are discharged, interposed therebetween. With such an arrangement, the feed mechanism 7 and the nutrunner 2 can be disposed with the magazine 8 as a center. This enables size reduction of a configuration including the nutrunner 2 and the supply device 3.

The magazine 8 accommodates the heads 300b of the plurality of bolts 300 and guides movement of the heads 300b in the direction in which the bolts 300 are fed by the feed mechanism 7. The magazine 8 also causes the shanks 300a of the bolts 300 fed by the feed mechanism 7 to protrude to the outside. Thus, the magazine 8 feeds the bolts 300 in cooperation with the feed mechanism 7. The magazine 8 is provided so as to be attachable to and detachable from the supply device 3.

As illustrated in FIG. 4, the magazine 8 includes a main body part 81 and a cover 82. The magazine 8 retains, by means of the main body part 81 and the cover 82, the heads 300b of the bolts 300 and portions of the shanks 300a which portions are in the vicinity of the heads 300b.

The main body part 81 is a plate-like member of rectangular shape having a predetermined thickness. The main body part 81 includes a retention groove 81a and a take-out opening 81b. The retention groove 81a is formed to open to one of opposed largest surfaces. The retention groove 81a is formed to extend in a longitudinal direction of the main body part 81and be bent toward an upper surface side of the main body part 81 at one end side of the retention groove 81a. The retention groove 81a has a width slightly larger than the diameter of the flange part of each of the heads 300b of the bolts 300 so as to stably guide the heads 300b. The take-out opening 81b is a portion where the retention groove 81a opens to the upper surface of the main body part 81, and is provided to allow the bolts 300 to be taken out from the magazine 8. The take-out opening 81b is formed on the side of one end part of the upper surface of the main body part 81.

Note that the shape of the main body part 81 is not limited to a rectangle and may be another shape such as a square.

The cover 82 covers a part of the retention groove 81a and has a function of pressing the shanks 300a of the bolts 300. The cover 82 includes a cover main body 82a, a slit 82b, and a pressing plate 82c.

The cover main body 82a is a plate-like member and covers a part of the retention groove 81a by being attached to a side of the main body part 81 on which side the shanks 300a of the bolts 300 are disposed. The slit 82b is provided in the cover main body 82a so as to extend along the retention groove 81a. A horizontally extending portion of the slit 82b is formed such that a height from a bottom of the retention groove 81a that is contacted by the head 300b (the flange part) of each bolt 300 is substantially equal to a width of the flange part. The slit 82b has a width slightly larger than that of the shank 300a of each bolt 300. Thus, a portion of the shank 300a which portion is in the vicinity of the head 300b is supported by a bottom surface of the slit 82b.

The pressing plate 82c is a plate-like portion provided on the cover main body 82a such that the pressing plate 82c protrudes, in a direction in which the shanks 300a extend, from a position between an upper edge of the cover main body 82a and an upper edge of the slit 82b, and is inclined such that a distal end part of the pressing plate 82c contacts the shanks 300a. The distal end part of the pressing plate 82c presses areas near the distal ends of the shanks 300a of the bolts 300, except for the bolt 300 positioned on the side of the take-out opening 81b. This prevents the shanks 300a from bouncing due to vibration and coming off from the helical groove 71a of the shaft 71.

Note that the pressing plate 82c is not an essential configuration of the magazine 8 and is provided as needed.

The supply mechanism 9 includes a gripping mechanism 91 and a moving mechanism 92. The gripping mechanism 91 is a mechanism that grips a bolt 300 fed by the feed mechanism 7. The moving mechanism 92 is a mechanism that moves the gripping mechanism 91 so as to supply the bolt 300 to the nutrunner 2.

The gripping mechanism 91 includes a pair of claws 91a and a drive section 91b. The claws 91a are provided so as to be openable and closable and have grooves at distal end parts thereof for gripping the bolt 300. The drive section 91b opens and closes the claws 91a. In a standby state, the claws 91a are open as shown in FIG. 2, and when the shank 300a of the bolt 300 reaches the distal end part on the shaft 71 of the feed mechanism 7 and becomes grippable, the claws 91a are closed to grip the shank 300a.

The moving mechanism 92 includes a rotation mechanism 93 and a linear moving mechanism 94. The rotation mechanism 93 rotates the gripping mechanism 91 by 90° between a vertical position oriented perpendicularly to the nutrunner 2 as illustrated in FIG. 2, and a parallel position parallel to the nutrunner 2. An angle by which the gripping mechanism 91 is rotated depends on a positional relationship between the nutrunner 2 and the feed mechanism 7. Therefore, the 90° indicated above is merely an example based on the positional relationship between the nutrunner 2 and the feed mechanism 7 in the present embodiment. The linear moving mechanism 94 is a mechanism that moves the rotation mechanism 93 linearly in a longitudinal direction of the nutrunner 2. The moving mechanism 92 is disposed at a position spaced apart from the nutrunner 2 by a predetermined distance.

The rotation mechanism 93 includes a support member 93a and a rotation actuator 93b. The support member 93a is a member formed in a rod-like, plate-like, or the like shape so as to support the drive section 91b of the gripping mechanism 91. The rotation actuator 93b drives the support member 93a so as to rotate the support member 93a within the above-described range.

The linear moving mechanism 94 moves a guide shaft 94a in a longitudinal direction of the guide shaft 94a by an air cylinder (not illustrated). The rotation actuator 93b is fixed to a distal end of the guide shaft 94a. Thus, the linear moving mechanism 94 moves the rotation mechanism 93 in parallel with the nutrunner 2 between a standby position near the distal end part of the shaft 71 of the feed mechanism 7 and a close position spaced slightly from a distal end of the nutrunner 2.

The feed mechanism 7 and the supply mechanism 9 are spaced apart from the socket 2c of the nutrunner 2. Accordingly, when the nutrunner 2 performs work in a narrow location using the bolt 300, it becomes easier to avoid interference of the feed mechanism 7 and the supply mechanism 9 with obstacles around the nutrunner 2.

The retention mechanism 10 is a mechanism that detachably retains the magazine 8. The retention mechanism 10 retains the magazine 8 on both sides of the magazine 8. For example, the retention mechanism 10 has grooves (not illustrated) that fit with ridges (not illustrated) provided on both side end faces of the magazine 8, and the magazine 8 is configured to be attachable to and detachable from the retention mechanism 10 by sliding of the ridges of the magazine 8 relative to the grooves of the retention mechanism 10. The structure by which the retention mechanism 10 retains the magazine 8 is not limited to the above structure, and various configurations may be adopted.

As described above, the magazine 8 is detachably held by the retention mechanism 10. Accordingly, a magazine 8 that has become empty because the bolts 300 have been sent out can be replaced with a magazine 8 loaded with bolts 300.

The control device 4 controls operations of the robot arm device 1 and the supply device 3. The control device 4 controls an operation of the nutrunner 2, and in particular, extends and retracts the nutrunner 2 in a state where the bolt 300 has been supplied. The control device 4 is provided so as to be attached to the robot arm device 1, but may be provided independently of the robot arm device 1. The operation of supplying the bolt 300 by the robot arm device 1 will be described in detail later.

Note that although the nutrunner 2 described above is a bolt fastening machine, in the present embodiment, a device having a work function other than the nutrunner 2 may be used as the work device. Further, although, in the supply device 3, the feed mechanism 7 is a mechanism that feeds the bolts 300 by movement of the helical groove 71a, the feed mechanism 7 may be a mechanism having a structure other than such a structure. Further, the feed mechanism 7 may be a mechanism that feeds an article to be supplied other than the bolts 300 and that has a structure adapted to the article.

### Bolt Supply Operation

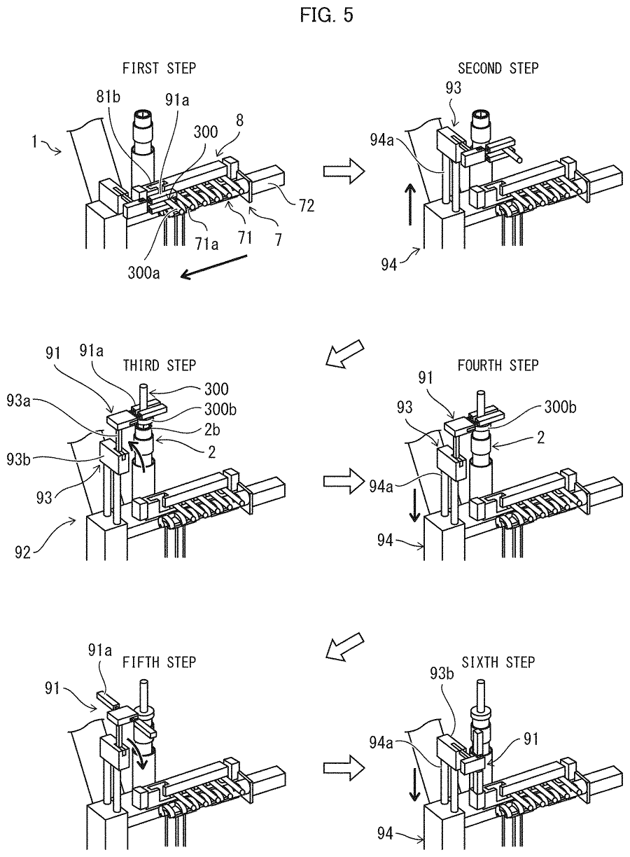

The following description will discuss an operation of (a method for) supplying the bolts 300 by the supply device 3 configured as described above. FIG. 5 is perspective views illustrating an operation in which the supply device 3 supplies a bolt to the nutrunner 2.

As illustrated in FIG. 5, first, in a first step, the shaft 71 of the feed mechanism 7 rotates to feed the shanks 300a of the bolts 300 disposed in the helical groove 71a of the shaft 71 in a direction indicated by an arrow (feeding step). When a bolt 300 thereby reaches the take-out opening 81b of the magazine 8, the claws 91a of the gripping mechanism 91 in the standby position close and grip the shank 300a of the bolt 300.

In a second step (supply step), the linear moving mechanism 94 of the moving mechanism 92 extends the guide shaft 94a by operation of the air cylinder to move the rotation mechanism 93 along the nutrunner 2.

In a third step (supply step), the rotation actuator 93b of the rotation mechanism 93 moves the claws 91a to above the nutrunner 2 by rotating the gripping mechanism 91 by 90°. In this state, the head 300b of the bolt 300 gripped by the claws 91a is at a position facing the socket 2c of the nutrunner 2.

In a fourth step (supply step), the linear moving mechanism 94 shortens the guide shaft 94a slightly by operation of the air cylinder to move the rotation mechanism 93 so that the claws 91a approach the nutrunner 2. As a result, the head 300b (hexagonal part) of the bolt 300 fits into the socket 2c. In this way, supply of the bolt 300 to the nutrunner 2 is completed.

In the fourth step, the following operation is performed to ensure that the bolt 300 correctly fits into the socket 2c of the nutrunner 2. First, while or after the claws 91a approach the nutrunner 2 in a state of gripping the bolt 300, the nutrunner 2 rotates at a low speed. When the head 300b fits into the socket 2c, torque is applied to the socket 2c, which has been idling until then, in a direction that impedes rotation. Then, the control device 4 recognizes that the bolt 300 has fitted into the socket 2c because a torque value measured by the socket 2c (the nutrunner 2) has increased.

In a fifth step, the claws 91a open, and then in a sixth step, the rotation actuator 93b rotates the gripping mechanism 91 in a direction opposite to that in the third step. Then, by the linear moving mechanism 94 further shortening the guide shaft 94a, the gripping mechanism 91 is moved back to the standby position.

Note here that, in the fifth or sixth step in the state where the bolt 300 has been supplied, the control device 4 may extend and retract the movable part 2b of the nutrunner 2. This allows the nutrunner 2 to change the form thereof in accordance with the work environment in the state where the bolt 300 has been supplied.

For example, in a narrow work environment, it is not possible to bring the entire nutrunner 2 close to a work area. As such, the movable part 2b is extended in a state where the bolt 300 has been supplied from the supply device 3. Further, in a case where work is performed after moving from a narrow work environment to a wide work environment, the entire nutrunner 2 can be brought close to the work area. As such, by contracting the movable part 2b, the supply device 3 can be brought closer to the socket 2c of the nutrunner 2 in preparation for the next work. This enables reducing the takt time of the supply device 3.

Further, the position of the socket 2c can be changed by extension and retraction of the movable part 2b. This enables changing the distance between the supply mechanism 9 and the socket 2c. Therefore, the nutrunner 2 can perform work for various work environments. For example, in a case where the work environment is quite narrow and the nutrunner 2 cannot be brought close to a work site together with the supply device 3, the position of the socket 2c is changed so that the socket 2c of the nutrunner 2 moves away from the supply device 3. Further, in a case where the takt time is to be reduced by shortening a distance over which the supply device 3 supplies the bolt 300 to the nutrunner 2, the position of the socket 2c is changed in the first step so that the socket 2c of the nutrunner 2 approaches the supply device 3.

Note that the nutrunner 2 may be used in a state where the movable part 2b is fixed so as not to extend and retract. This makes it possible to determine the accuracy of the position of the nutrunner 2 only by the movement of the robot arm device 1 when moving the nutrunner 2 to a work site.

### Effects of Embodiment

As described above, the robot device 100 includes the feed mechanism 7 and the supply mechanism 9.

In the above configuration, the bolts 300 are continuously fed by the feed mechanism 7, and a bolt 300 is supplied to the nutrunner 2 by the moving mechanism 92 moving the gripping mechanism 91 that is gripping the bolt 300. Further, because the retention parts 71b move within a certain region, dimensions of the feed mechanism 7 are determined substantially on the basis of a prescribed range. As such, compared to a configuration in which a portion that retains bolts (magazine) and a portion that moves the bolts (pushing-out part) are provided independently as in the configuration described in Patent Literature 1, the feed mechanism 7 can be made more compact. This enables size reduction of the supply device 3.

Further, the supply device 3 includes the magazine 8, so that as the shanks 300a are fed by the feed mechanism 7, the heads 300b move inside the magazine 8. In addition, the portions of the shanks 300a in the vicinity of the heads 300b are supported by the magazine 8. This makes it possible to stably feed the bolts 300 when the bolts 300 are fed by the feed mechanism 7 in a state where the shanks 300a are disposed so as to be oriented horizontally.

Further, the supply device 3 is provided at the distal end of the robot arm device 1. This makes it possible to automatically perform work by the nutrunner 2 at various work sites by operating the robot arm device 1.

### Variations

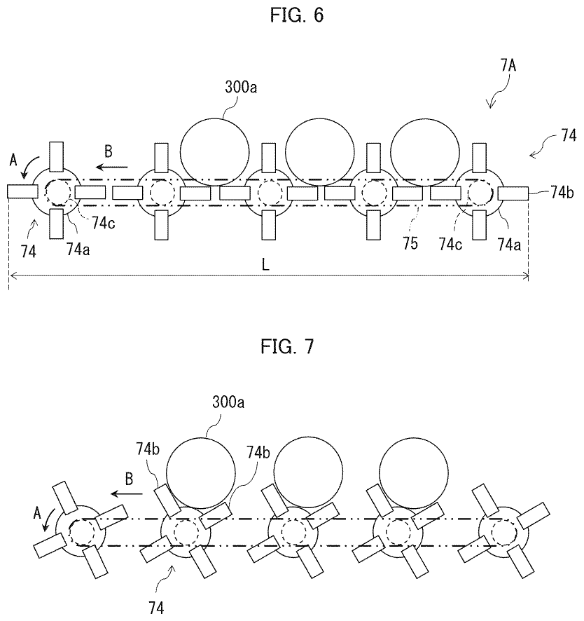

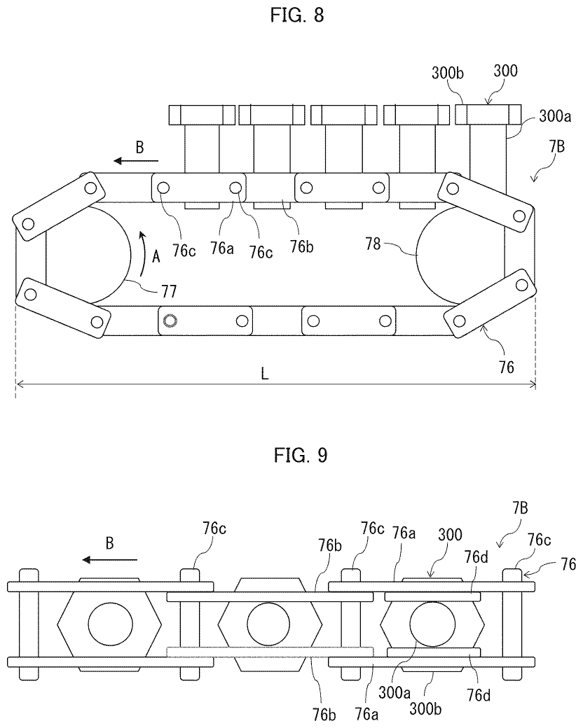

The following will describe variations of the present embodiment. FIG. 6 is a front view illustrating a configuration of a feed mechanism 7A in accordance with Variation 1 of the present embodiment. FIG. 7 is a front view illustrating a state in which bolts 300 are fed by the feed mechanism 7A. FIG. 8 is a front view illustrating a configuration of a feed mechanism 7B in accordance with Variation 2 of the present embodiment. FIG. 9 is a front view illustrating a state in which bolts 300 are fed by the feed mechanism 7B.

In Variation 1, a supply device 3 in a robot device 100 includes the feed mechanism 7A instead of the feed mechanism 7. The feed mechanism 7A, like the feed mechanism 7, is a mechanism that feeds bolts 300 in a linear direction. As illustrated in FIG. 6, the feed mechanism 7A includes a plurality of vane wheels 74 and a chain 75.

The plurality of vane wheels 74 are disposed so as to be aligned in a row. Each vane wheel 74 includes a rotary body 74a, four vane plates 74b, and a rotational shaft 74c.

The rotary body 74a has a cylindrical shape. The four vane plates 74b are attached to an outer circumferential surface of the rotary body 74a at a constant pitch so as to protrude radially. The rotational shaft 74c is provided coaxially with a center of the rotary body 74a and is provided so as to protrude from one end face of the rotary body 74a. The rotational shaft 74c of at least one of the plurality of vane wheels 74 is driven so as to rotate about a central axis of the rotational shaft 74c by a drive mechanism (not illustrated) including a motor or the like. A sprocket (not illustrated) is provided on the rotational shaft 74c.

Further, each adjacent pair of the vane wheels 74 are arranged such that, in a state where vane plates 74b are in horizontal positions as illustrated in FIG. 6, two adjacent vane plates 74b are close to each other with a slight spacing therebetween. These adjacent vane plates 74b constitute a retention part that retains a shank 300a of a bolt 300. Also, in a state where the vane plates 74b of each vane wheel 74 are not in horizontal positions, that is, in a state where the vane plates 74b are inclined relative to a horizontal plane as illustrated in FIG. 7, two adjacent vane plates 74b constitute a retention part that retains a shank 300a. Such retention parts are each provided in multiple numbers in the feed mechanism 7A and move, by rotation of the rotary bodies 74a in a direction of an arrow A, from the state illustrated in FIG. 6 to the state illustrated in FIG. 7 within a certain region having a prescribed length L. As a result, the bolts 300 are fed in a direction of an arrow B.

The chain 75 is hung so as to mesh with the sprockets provided on the rotational shafts 74c of the vane wheels 74 disposed at both ends. The chain 75 is also disposed so as to mesh, at upper and lower portions thereof, with the sprockets on the rotational shafts 74c of intermediate vane wheels 74.

Note that the number of vane plates 74b provided on each vane wheel 74 being four as described above is an example, and the number is not limited to four as long as the shanks 300a of the bolts 300 can be retained and fed as described above.

In the feed mechanism 7A configured as described above as well, the bolts 300 can be fed in the same manner as with the feed mechanism 7.

In Variation 2, a supply device 3 in a robot device 100 includes the feed mechanism 7B instead of the feed mechanism 7. The feed mechanism 7B, like the feed mechanism 7, is a mechanism that feeds bolts 300 in a linear direction. As illustrated in FIG. 8, the feed mechanism 7B includes a chain 76, a drive sprocket 77, and a driven sprocket 78.

The chain 76 includes a plurality of link plates 76a, a plurality of link plates 76b, a plurality of pins 76c, and a plurality of spacer plates 76d.

Each pair of link plates 76a are disposed to face each other at a spacing wider than a diameter of the shank 300a of a bolt 300 and narrower than a distance across corners of the head 300b of the bolt 300. Each pair of link plates 76b are disposed to face each other at a spacing substantially equal to the diameter of the shank 300a of a bolt 300. The pair of link plates 76a and the pair of link plates 76b are disposed alternately and are connected to each other at both end parts thereof by pins 76c. Each pair of spacer plates 76d are attached respectively to opposing surfaces of the pair of opposing link plates 76a. Each spacer plate 76d has a thickness equal to that of each link plate 76b.

The drive sprocket 77 includes, on an outer circumferential portion thereof, a plurality of teeth (not illustrated) that mesh with the chain 76. The drive sprocket 77 is rotationally driven in a direction of an arrow A by a drive mechanism (not illustrated). The driven sprocket 78 includes, on an outer circumferential portion thereof, a plurality of teeth (not illustrated) that mesh with the chain 76. The driven sprocket 78 is disposed spaced apart from the drive sprocket 77 by a predetermined distance. The driven sprocket 78 is rotatably supported in the feed mechanism 7B but is not driven. The chain 76 is hung over the drive sprocket 77 and the driven sprocket 78 and is thereby driven in a direction of an arrow B.

The pair of spacer plates 76d on each pair of link plates 76a constitute a retention part by retaining a shank 300a so as to sandwich the shank 300a therebetween. Further, the pair of link plates 76b constitute a retention part by retaining a shank 300a so as to sandwich the shank 300a therebetween. These retention parts are each provided in multiple numbers in the feed mechanism 7B and move, as the chain 76 moves in the direction of the arrow B, within a certain region having a prescribed length L. As a result, the bolts 300 are fed in the direction of the arrow B.

The bolts 300 are supplied from above at an end part of the chain 76 on the side of the driven sprocket 78. Specifically, a bolt 300 is supplied such that the shank 300a is pressed in between a pair of link plates 76a (the pair of spacer plates 76d) and between a pair of link plates 76b.

In the feed mechanism 7B configured as described above as well, the bolts 300 can be fed in the same manner as with the feed mechanism 7.

Aspects of the present invention can also be expressed as follows:

As described above, a supply device in accordance with Aspect 1 of the present invention includes: a feed mechanism that includes a plurality of retention parts for retaining an article to be supplied and that feeds the article in a linear direction by movement of the plurality of retention parts within a certain region; and a supply mechanism that includes (i) a gripping mechanism that grips the article fed by the feed mechanism and (ii) a moving mechanism that moves the gripping mechanism so as to supply the article to a work device that performs work with use of the article.

With the above configuration, the article is continuously fed by the feed mechanism, and the article is supplied to the work device by the moving mechanism moving the gripping mechanism that is gripping the article. Further, because the retention parts move within a prescribed range, dimensions of the feed mechanism are determined substantially on the basis of the prescribed range. As such, compared to configurations, such as the configuration described in Patent Literature 1, in which a portion (magazine) that retains an article to be supplied and a portion (pushing-out part) that moves the article are provided independently, the feed mechanism can be made more compact. This enables size reduction of the supply device.

A supply device in accordance with Aspect 2 of the present invention may be configured such that, in Aspect 1 above, the article is a bolt; the plurality of retention parts feed a shank of the bolt by retaining the shank; and the supply device further includes a magazine that accommodates heads of a plurality of the bolts such that shanks of the plurality of the bolts protrude to an outside, and that guides movement of the heads in a direction in which the plurality of the bolts are fed by the feed mechanism.

With the above configuration, as the shanks are fed by the feed mechanism, the heads move inside the magazine. In addition, the portions of the shanks in the vicinity of the heads are supported by the magazine. This makes it possible to stably feed the bolts when the bolts are fed by the feed mechanism in a state where the shanks are disposed so as to be oriented horizontally.

A supply device in accordance with Aspect 3 of the present invention may be configured such that, in Aspect 1 or 2 above, the feed mechanism and the supply mechanism are disposed spaced apart from a prescribed portion of the work device, to which prescribed portion the article is supplied.

With the above configuration, the feed mechanism and the supply mechanism can be disposed at positions distant from the prescribed portion of the work device. Accordingly, when the work device performs work in a narrow location using the article, it becomes easier to avoid interference of the feed mechanism and the supply mechanism with obstacles around the work device.

A supply device in accordance with Aspect 4 of the present invention may be configured such that, in Aspect 3 above, the plurality of retention parts retain a shank of the bolt such that the shank is oriented substantially perpendicular to a direction in which the work device faces.

With the above configuration, it is possible to secure a large gap between the feed mechanism including the retention parts and the prescribed portion of the work device, to which prescribed portion the article is supplied.

A supply device in accordance with Aspect 5 of the present invention may be configured such that, in Aspect 3 or 4 above, the article is a bolt; the plurality of retention parts feed a shank of the bolt by retaining the shank; the supply device further includes a magazine that accommodates heads of a plurality of the bolts such that shanks of the plurality of the bolts protrude to an outside, and that guides movement of the heads in a direction in which the plurality of the bolts are fed by the feed mechanism; and the feed mechanism is disposed on a side opposite to a side on which the work device is disposed, with the magazine interposed therebetween.

With the above configuration, the feed mechanism and the work device can be disposed with the magazine as a center. This enables size reduction of a configuration including the work device and the supply device.

A supply device in accordance with Aspect 6 of the present invention may be configured such that, in Aspect 2 above, the feed mechanism includes: a shaft that is rotationally driven about a central axis of the shaft; and a helical groove formed in an outer circumferential surface of the shaft.

With the above configuration, by disposing the shanks in the helical groove, the shanks can be moved in an axial direction of rotation. This allows bolts to be fed at a constant pitch.

A robot device in accordance with Aspect 7 of the present invention includes: a supply device described in any one of Aspects 1, 2, 3, 4, and 6 above; a work device that performs work with use of the article supplied by the supply device; and a robot arm device including a joint so as to be rotatable, wherein the supply device and the work device are provided at a distal end of the robot arm device.

With the above configuration, work by the work device using the article can be automatically performed at various work sites by operating the robot arm device.

A robot device in accordance with Aspect 8 of the present invention may be configured such that, in Aspect 7 above, the work device is provided so as to be extendable and retractable, and the robot device further includes a control device that extends and retracts the work device in a state where an article to be supplied is supplied.

With the above configuration, the work device to which the article has been supplied can change the form thereof in accordance with the work environment. For example, in a narrow work environment, it is not possible to bring the entire work device close to a work area. As such, the work device is extended in a state where the article has been supplied from the supply device. Further, in a case where work is performed after moving from a narrow work environment to a wide work environment, the entire work device can be brought close to the work area. As such, by contracting the work device, the supply device can be brought closer to the prescribed portion of the work device in preparation for the next work. This enables reducing the takt time of the supply device.

A robot device in accordance with Aspect 9 of the present invention may be configured such that, in Aspect 7 above, a position of a prescribed portion of the work device, to which prescribed portion the article is supplied, is changeable.

With the above configuration, by changing the position of the prescribed portion of the work device, it is possible to change the distance between the supply mechanism and the prescribed portion. Therefore, the work device can perform work for various work environments. For example, in a case where the work environment is quite narrow and the work device cannot be brought close to a work site together with the supply device, the position of the prescribed portion of the work device is changed so that the prescribed portion moves away from the supply device. Further, in a case where the takt time is to be reduced by shortening a distance over which the supply device supplies the article to the work device, the position of the prescribed portion of the work device is changed so that the prescribed portion approaches the supply device.

A supply method in accordance with Aspect 10 of the present invention includes: a feeding step of feeding an article to be supplied with use of a feed mechanism that includes a plurality of retention parts for retaining the article and that feeds the article in a linear direction by movement of the plurality of retention parts within a certain region; and a supply step of, while gripping the article fed by the feed mechanism, moving the article so as to supply the article to a work device that performs work with use of the article.

With the above configuration, the article is continuously fed in the feeding step, and the article is supplied to the work device in the supply step by moving the article while the article is gripped. Further, because the retention parts move within a prescribed range, dimensions of the feed mechanism are determined substantially on the basis of the prescribed range. As such, as described above, the feed mechanism can be made more compact. This enables size reduction of the supply device that implements the supply method.

### Additional Remarks

The present invention is not limited to the embodiments above, but can be altered in various ways by a skilled person in the art within the scope of the claims. The present invention also encompasses, in its technical scope, any embodiment derived by appropriately combining technical means disclosed in differing embodiments.

### REFERENCE SIGNS LIST

1: Robot arm device
2: Nutrunner (work device)
2c: Socket (prescribed portion)
3: Supply device
4: Control device
7, 7A, 7B: Feed mechanism
8: Magazine
9: Supply mechanism
71b: Retention part
74b: Vane plate (retention part)
91: Gripping mechanism
100: Robot device
300: Bolt (article (to be) supplied)

1. A supply device, comprising:
a feed mechanism that includes a plurality of retention parts for retaining an article to be supplied and that feeds the article in a linear direction by movement of the plurality of retention parts within a certain region; and
a supply mechanism that includes (i) a gripping mechanism that grips the article fed by the feed mechanism and (ii) a moving mechanism that moves the gripping mechanism so as to supply the article to a work device that performs work with use of the article.

2. The supply device as set forth in claim 1, wherein:
the article is a bolt;
the plurality of retention parts feed a shank of the bolt by retaining the shank; and
the supply device further comprises
a magazine that accommodates heads of a plurality of the bolts such that shanks of the plurality of the bolts protrude to an outside, and that guides movement of the heads in a direction in which the plurality of the bolts are fed by the feed mechanism.

3. The supply device as set forth in claim 1, wherein the feed mechanism and the supply mechanism are disposed spaced apart from a prescribed portion of the work device, to which prescribed portion the article is supplied.

4. The supply device as set forth in claim 3, wherein:
the article is a bolt; and
the plurality of retention parts retain a shank of the bolt such that the shank is oriented substantially perpendicular to a direction in which the work device faces.

5. The supply device as set forth in claim 3, wherein:
the article is a bolt;
the plurality of retention parts feed a shank of the bolt by retaining the shank;
the supply device further comprises
a magazine that accommodates heads of a plurality of the bolts such that shanks of the plurality of the bolts protrude to an outside, and that guides movement of the heads in a direction in which the plurality of the bolts are fed by the feed mechanism; and
the feed mechanism is disposed on a side opposite to a side on which the work device is disposed, with the magazine interposed therebetween.

6. The supply device as set forth in claim 2, wherein the feed mechanism includes: a shaft that is rotationally driven about a central axis of the shaft;
and a helical groove formed in an outer circumferential surface of the shaft.

7. A robot device, comprising:
a supply device recited in claim 1;
a work device that performs work with use of the article supplied by the supply device; and
a robot arm device including a joint so as to be rotatable,
wherein the supply device and the work device are provided at a distal end of the robot arm device.

8. The robot device as set forth in claim 7, wherein:
the work device is provided so as to be extendable and retractable; and
the robot device further comprises a control device that extends and retracts the work device in a state where an article to be supplied is supplied.

9. The robot device as set forth in claim 7, wherein a position of a prescribed portion of the work device, to which prescribed portion the article is supplied, is changeable.

10. A supply method, comprising:
a feeding step of feeding an article to be supplied with use of a feed mechanism that includes a plurality of retention parts for retaining the article and that feeds the article in a linear direction by movement of the plurality of retention parts within a certain region; and
a supply step of, while gripping the article fed by the feed mechanism, moving the article so as to supply the article to a work device that performs work with use of the article.
